(19) United States
(12) Patent Application Publication
(10) Pub. No.: US 2008/0138500 A1
(43) Pub. Date: Jun. 12, 2008

(54) Method and Machine for Manufacturing Electrical Circuits

(76) Inventor: Alessandro Spaggiari, (Reggio Emilia) (IT)

Correspondence Address: NATH & ASSOCIATES, 112 South West Street, Alexandria, VA, 22314, US

(21) Appl. No.: 11/795,205

(22) PCT Filed: Jan. 24, 2006
(86) PCT No.: PCT/IB06/00108

§ 371 Date: Jul. 13, 2007

(30) Foreign Application Priority Data
Jan. 31, 2005 (IT) BO2005A0000048

(51) Int. Cl. B05D 5/12; B05C 11/02

(52) U.S. Cl. 427/58; 118/37

(57) ABSTRACT

The machine (1) for manufacturing electrical circuits (2) from a web (3) of electrically conductive material comprises means (4) for feeding the web (3) along a defined path (P), a stamping station (11) for applying a certain quantity of insulating varnish on certain portions of the web (3) and a punching station (22) for cutting the electrical circuits (2) out of the web (3).

### TECHNICAL FIELD

This invention relates to a method for manufacturing electrical circuits.

In particular, but without thereby limiting its scope, the invention relates to a method for manufacturing electrical circuits for powering the brushes of electric motors.

### BACKGROUND ART

In an electric motor, brush wear caused by the turning commutator leads to the formation of dust consisting of particles of electrically conductive material scattered around the commutator.

When used for motorcycle and automotive vehicle applications, the motors must be protected against infiltration, for example of rain water.

To obtain this type of protection, the motor guards are made watertight.

The watertight guards, however, trap the particles of electrically conductive material inside the casing, causing them to accumulate on the circuits and eventually creating short circuits or interrupting the power supply as a result of the creation of electrical bridges.

In the latter case, power is not distributed equally between the brushes and the balance required for correct operation is altered.

Methods of embedding electrical circuits, which are often formed or punched from a sheet or web of electrically conductive material, in the structure of the brush holder were therefore devised to overcome this problem.

This solution, however, although certainly effective, proved complex and expensive to implement.

Moreover, the circuits can be embedded only in brush holders made of plastic because the high melting point of metal would damage the electrical conductors during the forming process.

To overcome this problem, brush holders with recesses to precisely accommodate the circuits were made so that the circuits were exposed to dust only at the top.

This solution, however, while offering undoubted advantages in terms of simplicity has the drawback of not fully solving the problem of short circuiting and electrical bridging.

To overcome this drawback, a method of coating electrical circuits by dipping them in a suitable insulating material was devised.

This method of manufacturing electrical circuits, however, although it effectively insulates the circuits from electrically conductive dust, has evident disadvantages in terms of cost and complexity.

Indeed, after the circuit has been dipped in the insulating material and dried, the insulating material has to be removed from the parts of the circuit to be connected to the electrical conductors.

Owing to the very small size of the circuits, the operation of cleaning the contacts is difficult to perform and may result in poor electrical conduction. In other terms, it may give rise to the very problem that coating the circuit was designed to eliminate.

This invention therefore has for an aim to provide a method for manufacturing electrical circuits that is free of the above mentioned disadvantages and that is at once practical and inexpensive to implement.

### DISCLOSURE OF THE INVENTION

The technical characteristics of the invention, with reference to the above aim may be clearly inferred from the contents of the appended claims, especially claim 1, and any of the claims that depend, either directly or indirectly, on claim 1.

This invention also relates to a machine for manufacturing electrical circuits.

The machine according to the invention is described in claim 11, and any of the claims that depend, either directly or indirectly, on claim 11.

### BRIEF DESCRIPTION OF THE DRAWINGS

The technical characteristics of the invention, with reference to the above aims, are clearly described in the claims below and its advantages are apparent from the detailed description which follows, with reference to the accompanying drawings which illustrate a preferred embodiment of the invention provided merely by way of example without restricting the scope of the inventive concept, and in which:

FIG. 1 is a schematic perspective view of a preferred embodiment of a machine for manufacturing electrical circuits according to the present invention;

FIGS. 2 to 7 illustrate a part of the machine of FIG. 1 in a sequence of operating steps.

### DETAILED DESCRIPTION OF THE PREFERRED EMBODIMENTS OF THE INVENTION

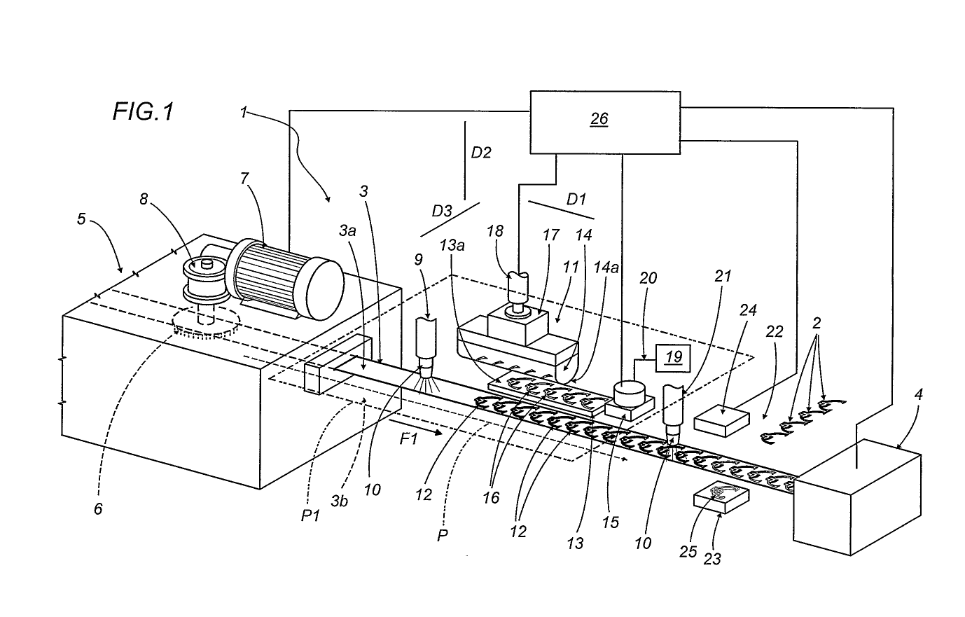

With reference to FIG. 1, the numeral 1 denotes in its entirety a machine for manufacturing electrical circuits 2 from a web 3 of electrically conductive material.

The machine 1, which is represented schematically in the accompanying drawings, comprises means for feeding the web 3 along a defined feed path P.

The web feed means are represented schematically as a block 4.

The machine 1 also comprises a web cleaning station 5 equipped with one or more rotary brushes 6 and a pickling unit, not illustrated, the term “pickling” denoting a cleaning process performed by chemical or electrolytic means.

The brush 6 is rotationally driven by an electric motor 7 through a reduction unit 8.

At the outfeed end of the cleaning station 5, the machine 1 comprises a first unit 9, for drying the web 3, the unit 9 comprising an element 10 for blowing warm air on the web 3.

Downstream of the cleaning station 5, relative to the feed direction indicated by the arrow Fl, the machine 1 comprises a stamping station 11 where a certain quantity of insulating varnish is applied to the web 3 in such a way as to form a plurality of impressions 12 on it. Each impression 12 covers a certain portion of the web 3 and reproduces the final form that the electrical circuit 2 will eventually have, though slightly larger in size.

The web 3 stamping station 11 comprises a pattern 13, a first pad 14 and second pad 15.

The pattern 13 is shaped substantially like a parallelepiped and has on its upper face 13a a plurality of cavities 16, each reproducing the above mentioned impression 12.

The cavities 16 are distributed in succession in a first direction D1 parallel to the straight section of the feed path P at the stamping station 11.

The first pad 14 is prismatic in shape, with a convex bottom face 14a, and is made of a resilient material, advantageously based on silicone.

The first pad 14 is mounted on a block 17 which is in turn stably connected to an operating arm 18.

The operating arm 18 is moved by actuating means, not illustrated in a second direction D2 perpendicular to a plane P1 in which the web 3 lies when it is at the stamping station.

The operating arm 18 is also moved by the same actuating means, not illustrated, in a third direction D3 perpendicular to the second direction D2 and parallel to the plane P1.

The second pad 15 is moved in reciprocating fashion by actuating means, which are not illustrated, in the above mentioned first direction D1 and, during its movement, engages the top face 13a of the pattern 13 and transfers a certain amount of insulating varnish to it.

The insulating varnish, stored in a tank that is schematically represented as a block 19, is fed by the tank to the second pad 15 through a conduit 20.

Similarly to what is described above, the machine 1 also comprises, at the outfeed end of the stamping station 11, a second drying unit 21 for quickly drying the insulating varnish applied to the web 3. The second drying unit 21 comprises an element 10 for blowing warm air on the web 3.

Downstream of the stamping station 11, the machine 1 further comprises a punching station 22 for cutting the circuits 2 out of the web 3 by punching.

As illustrated schematically in FIG. 1, the punching station 22 comprises a die 23 and a matrix 24.

The die 23, shown under the web 3 in the accompanying drawings, has the design 25 of a circuit 2 made in it in relief, whilst the matrix 24, non illustrated in detail in the drawings, has on it the same design of the circuit 2 but in this case the design is recessed.

According to methods described in more detail below, the relief design 25 and the recessed design that is not illustrated engage each other and the web 3 in such a way as to punch out a circuit 2.

Downstream of the punching station 22, again relative to the direction indicated by the arrow F1, the machine 1 comprises the aforementioned web 3 feed means 4.

A block 26 in FIG. 1 schematically represents a control unit. The control unit 26 controls and coordinates the operation and movement of all the parts of the machine 1.

In use, the web 3 of electrically conductive material is unwound from a roll, which is not illustrated in the drawings, and fed towards the cleaning station 5.

In the station 5, the web 3, which has a top face 3a and a bottom face 3b, is cleaned both by mechanical means and by pickling.

More specifically, mechanical cleaning is accomplished by brushing at least the top face 3a to which the varnish is applied, using the aforementioned rotary brushes 6, one of which is shown in FIG. 1, drawn in dashed line style.

Pickling, as mentioned above, may be carried out either using suitable chemicals, selected according to the type of metal the web is made of, or by an electrolytic process. Both methods are well known in the trade and are not therefore described in this specification.

Still with reference to FIG. 1, after leaving the cleaning station 5, the web 3, which is advanced in steps by the feed means 4, is struck at least on its top face 3a by a jet of warm air emitted by the blowing element 10 of the first drying unit 9.

The jet of warm air is designed to dry the top face 3a to remove any traces of liquid substances used during the previous, cleaning step.

Again with reference to FIG. 1, the web 3 advances along the feed path P, in the direction indicated by the arrow F1, and reaches the stamping station 11.

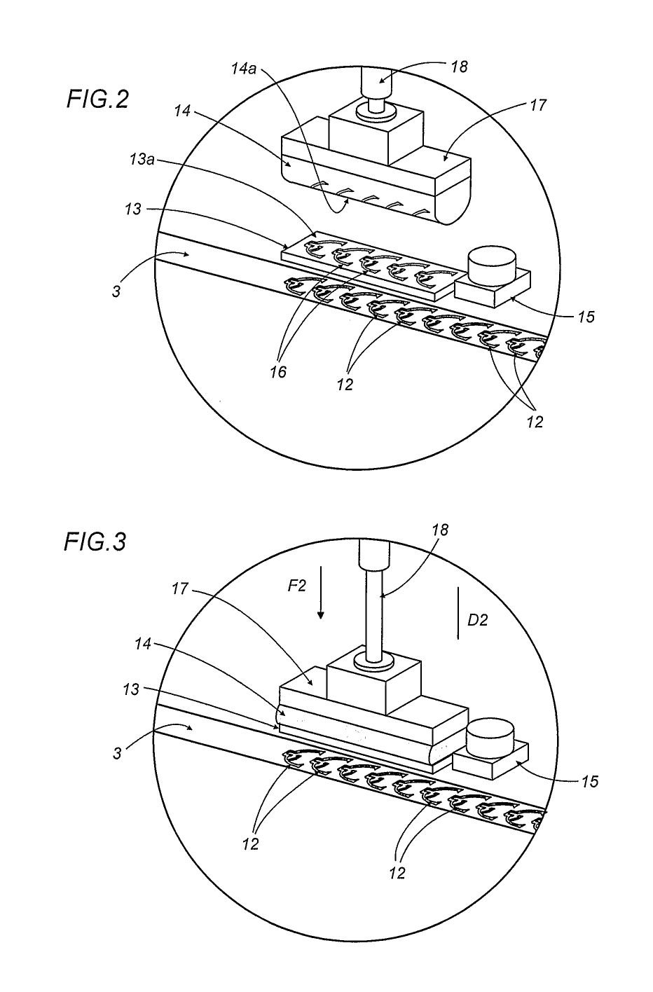

The following detailed description of the operations carried out at the stamping station 11 is made with reference to FIGS. 2 to 7, which are scaled-up views of the station 11 itself.

As shown in FIG. 2, the operating arm 18, driven by respective actuating means that are not illustrated, positions the first pad 14 above the pattern 13 in such a way that the convex, bottom face 14a of the first pad 14 itself faces the top face 13a of the pattern 13.

The cavities 16 reproducing the impression 12 are full, that is to say, each cavity 16 contains a sufficient quantity of insulating varnish.

The operations by which they are filled are described in more detail below.

With reference to FIG. 3, the operating arm 18 moves down in the direction D2, as indicated by the arrow F2, to place the first pad 14 in a first end position in which it is in contact with the top face 13a of the pattern 13. The first pad 14 is deformed by compression.

In FIG. 3, the face 13a is hidden by the first pad 14.

At its aforementioned first end position, thanks to the high deformability of the material it is made of and to the compressive action exerted by the arm 18, the first pad 14 penetrates inside the cavities 16 of the pattern 13 and its bottom face 14a receives a certain quantity of varnish from the cavities 16.

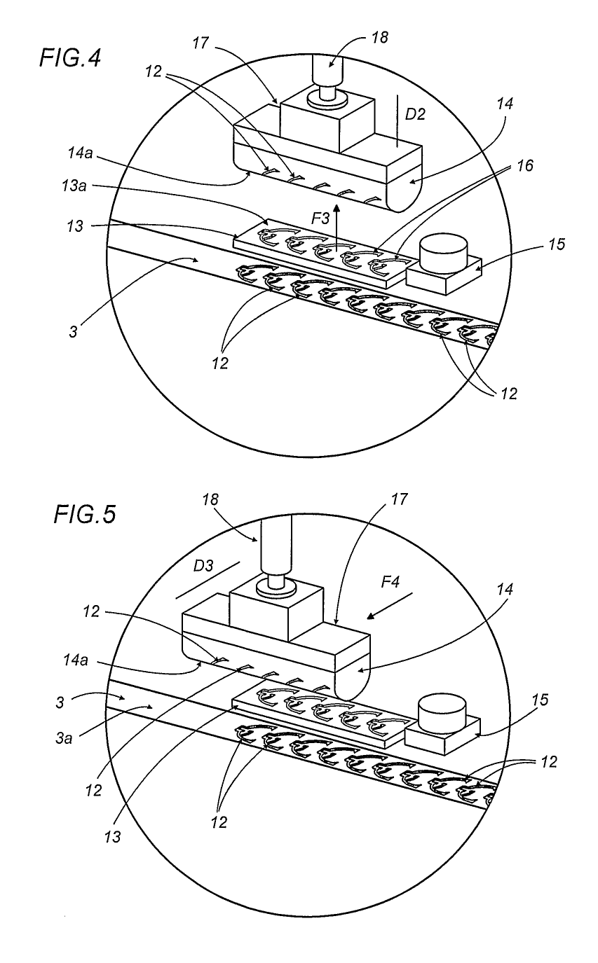

In other words, as clearly illustrated in FIG. 4, some of the varnish that was previously inside the cavities 16 is transferred to the bottom face 14a according to the aforementioned impression 12.

FIG. 4 shows the pad 14 after the arm 18 has lifted it in the direction of the arrow F3, causing the faces 13a, 14a of the pattern 13 and of the first pad 14, respectively, to move apart.

As shown in FIG. 5, the arm 18, controlled by the unit 26, advances in the direction D3, as indicated by the arrow F4, and moves the first pad 14 to the position where its bottom face 14a faces the web 3 of electrically conductive material.

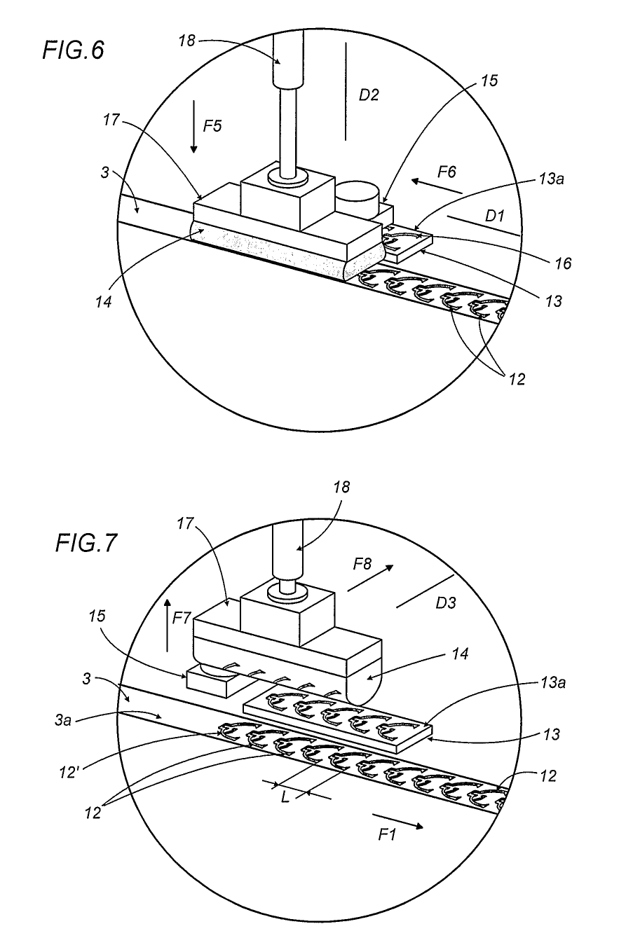

With reference to FIG. 6, the arm 18 extends downwardly in the direction indicated by the arrow F5 and moves the first pad 14 down to a second end position in which it is in contact with the web 3 of electrically conductive material. The first pad 14 is deformed by compression.

At this second end position, the first pad 14 transfers to the top face 3a of the web 3 at least a part of the varnish that it had received in the form of impressions 12 on its bottom convex face 14a.

In FIG. 6, the second pad 15 has started moving in the direction D1 indicated by the arrow F6 to meter the insulating varnish transferred to the top face 13a of the pattern 13.

More specifically, the second pad 15 moves over the pattern 13 twice and, as it does so, releases a quantity of insulating varnish that is transferred not only to the inside of the cavitities 16 but also to the smooth surface of the face 13a.

While releasing the varnish, the second pad 15 also exerts a scraping action on the top face 13a of the pattern 13. As a result of this scraping action, when the second pad 15 has moved over the pattern 13 for the second time, that is to say, when the second pad 15 has returned to the position shown in FIG. 5, the insulating varnish is located only inside the cavities 16.

As illustrated in FIG. 7, in which the arm 18 has already lifted the first pad 14 in the direction indicated by the arrow F7, another impression, labelled 12′ for clarity, appears on the top face 3a of the web 3 as a result of the first pad 14 transferring insulating varnish when it is in its second end position, illustrated in FIG. 6.

The working cycle of the first pad 14 is completed when the operating arm 18 moves back in the direction D3 as indicated by the arrow F8 to the position shown in FIG. 2, ready to start another cycle.

While the first pad 14 performs this movement, the second pad 15 moves over the pattern 13 a second time in the direction indicated by the arrow Fl to return to the position illustrated in FIG. 2, and the feed means 4 advance the web 3 along its path P in the direction indicated by the arrow F1, shown in FIGS. 1 and 7, by a step L equal to the spacing between one impression 12 and the next.

The spacing L between the impressions 12 made on the web 3 is equal to the spacing between the cavities 16 in the pattern 13.

Advantageously, a device, not illustrated, is positioned on the path P between the second drying unit 21 and the punching station 22 for applying a lubricating substance to the web 3, for example by spraying, in order to facilitate the cutting action of the punching die 23.

Advantageously, to enable the insulating varnish to be progressively layered on the web 3, the impressions 12 are obtained by repeated stamping actions of the first pad 14. For example, in the embodiment illustrated in the accompanying drawings, each finished impression 12 is made by the first pad 14 applying varnish to the web 3 in five successive stamping actions.

As illustrated in FIG. 1, after leaving the stamping station 11, the web 3, which is advanced in steps by the feed means 4, is struck by a jet of warm air emitted by the blowing element 10 of the second drying unit 21.

This jet of warm air is designed to quickly dry the insulating varnish that has been applied to the web 3.

As it proceeds along the path P, each portion of the web 3 reaches the punching station 22 where it is engaged by the die 23 and the matrix 24.

The die 23 and matrix 24 move towards each other in substantially known manner and by means of actuators that are well known and therefore not described in detail in this specification, so as to engage each other and the web 3 to form the electrical circuits 2 by punching.

The die 23 which, through the relief design 25, physically cuts the electrical circuit 2 out of the web 3, engages the lower face 3b of the web 3, whilst the matrix 24 opposes the action of the die 23 by acting on the top face 3a.

Advantageously, in an alternative embodiment of the machine 1 that is not illustrated, the web 3 engages a feed roller which positions the web with its top face 3a—that is, the one on which the impressions 12 are made—down so that the electrical circuits 2 drop when they are punched out.

In this specification, the term “varnish” means any fluid insulating material that can be applied to a web of electrically conductive material and that will adhere permanently to the web.

In this specification the phrase “punch at least partly” denotes the fact that at least a part of the web portions coated with insulating varnish are cut out.

Indeed, for safety reasons, a part around the edges of the coated portions remain on the punched web. This is done for safety reasons because it would be extremely risky to cut out from the web a circuit that is not perfectly and completely coated with insulating varnish. It would indeed be extremely difficult and unduly expensive to provide means for exactly cutting out only the web portions that have been coated with varnish.

Advantageously, the web 3 that leaves the punching station 22, that is to say the part of the web from which the circuits 2 have been punched out, can easily be surface cleaned, melted down and re-used.

The invention described has evident industrial applications and may be subject to modifications and variations without thereby departing from the scope of the inventive concept. Moreover, all the details of the invention may be substituted by technically equivalent elements.

1. A method for manufacturing electrical circuits (2) characterised in that it comprises:
the step of step-feeding a web (3) of electrically conductive material along a path (P);
the step of coating certain portions of the web (3) with an insulating varnish;
the step of punching the given portions of the web (3) at least partly to define the electrical circuits (2).

2. The method according to claim 1, characterised in that the step of coating certain portions comprises the step of applying to the web (3) a given quantity of varnish to make a given impression (12).

3. The method according to claim 2, characterised in that the step of applying the varnish comprises the step of receiving the varnish from a pattern (13) and transferring the varnish to the web (3).

4. The method according to claim 3, characterised in that the step of applying the varnish to the web (3) is performed by a first pad (14) made of a resilient material.

5. The method according to claim 3, characterised in that it comprises a step of metering the varnish transferred to the pattern (13).

6. The method according to claim 2, characterised in that it comprises a step of drying the varnish applied to the web (3).

7. The method according to claim 1, characterised in that it comprises a step of cleaning at least one face (3a, 3b) of the web (3) to improve the adhesion of the varnish to the web (3) itself.

8. The method according to claim 1, characterised in that the cleaning step comprises the step of brushing the web (3).

9. The method according to claim 1, characterised in that the cleaning step comprises the step of pickling at least one face of the web (3).

10. The method according to claim 1, characterised in that it comprises a step of spraying a lubricating substance on the web (3) in order to facilitate the punching step.

11. A machine for manufacturing electrical circuits (2) characterised in that it comprises:
means for feeding a web (3) of electrically conductive material along a path (P);
a stamping station for applying a given quantity of insulating varnish to given portions of the web (3);
a punching station for punching the given portions at least partly to define the electrical circuits (2).

12. The machine according to claim 11, characterised in that the stamping station (11) comprises a first pad (14) designed to apply a given quantity of varnish to the web (3) to make a given impression (12).

13. The machine according to claim 12, characterised in that it comprises a pattern (13) from which the first pad (14) receives the varnish to be applied to the web (3).

14. The machine according to claim 13, characterised in that the pattern (13) comprises a cavity (16) that reproduces the impression (12), the cavity (16) being designed to hold a certain quantity of the varnish.

15. The machine according to claim 14, characterised in that the pattern (13) comprises a plurality of cavities (16), the cavities (16) being distributed in succession in a first direction (Dl) parallel to the web (3) feed path (P) at the stamping station (11).

16. The machine according to claim 13, characterised in that it comprises a second pad (15) for transferring the varnish to the pattern (13).

17. The machine according to claim 13, characterised in that the first pad (14) is mobile between a first end position in which it is in contact with the pattern (13) and where its face (14a) receives a given quantity of varnish in the shape of the impression (12), and a second end position in which it is in contact with the web (3) of electrically conductive material and where it at least partly transfers the given quantity of varnish to the web (3).

18. The machine according to claim 11, characterised in that it comprises step-feeding means (4) for advancing the web (3) in defined steps (L).

19. The machine for manufacturing electrical circuits (2) characterised in that it comprises:
means for feeding a web (3) of electrically conductive material along a path (P);
a stamping station for applying a given quantity of insulating varnish to given portions of the web (3);
a punching station for punching the given portions at least partly to define the electrical circuits (2), characterised in that it comprises step-feeding means (4) for advancing the web (3) in defined steps (L), when it depends directly or indirectly on claim 15, characterised in that the spacing between each of the plurality of cavities (16) on the pattern (13) and the cavity (16) adjacent to it is equal to the feed step (L) of the web (3).

20. The machine according to claim 11, characterised in that it comprises a station (5) for cleaning the web (3).

21. An electrical circuit characterised in that it is manufactured according to a method as defined in claim 1.

22. An electrical circuit characterised in that it is manufactured using a machine (1) as defined in claim 11.
